(19) United States
(12) Patent Application Publication
(10) Pub. No.: US 2004/0102105 A1
(43) Pub. Date: May 27, 2004

(54) Spring cap and electric component

(76) Inventors: Eva Steiner, Hohenlinden (DE); Egon Heringer, Oberhausen (DE); Thomas Mielke, Munich (DE)

Correspondence Address: FISH & RICHARDSON PC, 225 FRANKLIN ST, BOSTON, MA, 02110, US

(21) Appl. No.: 10/470,687

(22) PCT Filed: Feb. 4, 2002
(86) PCT No.: PCT/DE02/00407

(30) Foreign Application Priority Data
Feb. 14, 2001 (DE) 101-06-837.9

(51) Int. Cl. H01R 11/22

(52) U.S. Cl. 439/856

(57) ABSTRACT

A spring cap (10), specifically for an electrical component, has a yoke (11) with a central planar area (12) and spring shackles (17) on two opposite sides and handles (13) designed as spring shackles on two opposite sides. The electrical component has a bobbin (20) with connectors (24, 25) attached to it, a magnetic core (30), the parts of which mate with the bobbin by means of a central boss (31), and the spring cap which can be pushed up onto the core which is mated with the bobbin, the handles of which spring cap are in contact with the connectors and the spring shackles of which are in contact with the magnetic core.

This invention relates to a spring cap, specifically for an inductive electrical component which has a yoke and handles on two opposite sides and spring shackles on two opposite sides, as well as an electrical component which has a bobbin with bobbin flanges at the end and connectors attached to it, a divided magnetic core, the parts of which mate with the bobbin by means of a central boss, and a spring cap which can be pushed up onto the core which is mated with the bobbin, which spring cap contains a yoke and handles on two opposite sides and spring shackles on two opposite sides, whereby when the spring cap is pushed up, the handles are in contact with the connectors and the spring shackles are in contact with the magnetic core.

This kind of spring cap and electrical component are known from EP 0594031.

The conventional design of an electrical component, e.g. a transformer, has a bobbin and a so-called E- or Q-core which can be attached to this, which is preferably made of ferrite material and is composed of several parts, e.g. two core halves. The bobbin has a coil space demarcated by two bobbin flanges with a cylindrical through-hole to receive central bosses of the E- or Q-core halves. The bobbin also has attached connectors which are, for example, made as one piece with the bobbin and contain contact pins for electrical contact of the component after it is mounted on a printed circuit board.

The two E-core halves shown in the example with central bosses and core handles can be pushed onto the bobbin in such a way that the central bosses mate with the cylindrical through-hole and typically sit on the cylindrical interior part of the bobbin.

In the conventional design with a so-called EP-core, the core halves are held on the bobbin using a spring cap. The spring cap has a concave-designed yoke and handles on two opposite sides and spring shackles on two other opposite sides. When the spring cap is pushed up, the concave yoke area attaches to the exterior side of the magnetic core that is not facing the connectors. The handles are adjacent to the exterior sides of the core halves and the connectors, and are snapped on by snap-on lugs on related notches on the underside of the connectors [tr.: hereinafter “underside notches”]. The spring shackles press against opposing sides of the magnetic core.

After the snap-on lugs have been snapped onto the connectors, the concave-shaped yoke of the spring cap exerts traction between the connectors and the core halves so that the core halves are pressed onto the bobbin and held vertically to the axis of the bosses of the core. In addition, the spring shackles that are pressing on the core halves ensure a pressure in the direction of the axis of the bosses of the core (also magnetic axis of the transformer).

Another design of a typical transformer has a so-called Q-core in the form of two core halves, whereby this design is generally the same as the aforementioned EP-core design as regards the bobbin and the ferrite core.

However, designs of the aforementioned kind are not well-suited as components that can be surface mounted, because, firstly, parts such as contact pins, earthing pins and other joints project downwards over the lower demarcation of the connectors and are required to be set into pre-prepared holes of a circuit board. Secondly, the spring cap must be laboriously fastened on its own or, or in such fashion to allow it to be pushed up onto the core by a pick-up and positioning tool such as a suction grab, because the yoke of the spring cap has to be concave in the central area so that it develops spring properties and can exert traction between core and bobbin when it is working in tandem with the snap-on lugs. In addition, manufacture of the concave yoke of the spring cap requires special equipment and separate procedures.

The function of the present invention is to create a spring cap and an electrical component of the kind in question that are suitable for surface mounting.

This function is fulfilled by the features in patent claims 1 and 9 respectively.

The spring cap and/or electrical component described in the individual patent claims has the advantage that they are suitable for surface mounting of components, because the yoke of the spring cap is planar at least in its central area or even throughout its whole surface. This means that it can be very easily and reliably grabbed automatically, for instance, by a suction grab and then positioned (so-called pick and place). The large planar surface results in great work tolerances for this process, making mounting altogether better. In addition, the planar surface of the spring cap can be easily marked so that the data put on it can be read easily from above after mounting on a circuit board.

The handles that are designed as spring shackles and that press against the connector and the planar yoke of the spring cap cause no resulting traction other than the frictional resistance of the handles in the related area of the underside notches of the connectors of the bobbin. The core parts are held securely in place in relation to the bobbin without force being exerted on the core or the core parts themselves by the handles. Now, only the force exerted by the spring shackles of the other sides has an effect on the core parts. Because there is no traction between the spring cap and the contact pins, the central bosses of the core that are sensitive to breakage are no longer pressed forcibly against the cylindrical inner part of the bobbin, and there is a reduced danger of breakage of the core, which would make the component incapable of functioning. The invention also permits the core layers to move slightly against each other when the spring cap is mounted and to be pressed downwards and fixed only when the spring cap is pushed up by the upward thrust.

The spring cap allows greater security in the process for surface mounting of the component because at least one surface of the yoke required for the pick-and-place procedure is planar. With no cap, the core halves of the component may be mounted in misalignment to each other and become stuck, and then, the corresponding pick-and-place work surface is no longer even.

The design of the handle-spring shackles with the snap-on lugs and the related underside notches of the bobbin can be done very accurately causing form and frictional resistance. The production tolerances of the corresponding elements can be very small, e.g. +/−50 μm, because the much larger spreading core parts have no seal with the handles. The lip of the end section of the handle-spring shackles can be very fine with small tolerances because the latter only have to be adjusted to the snap-on lug elements or underside notches of the connector. In contrast to this, the spring shackles of the other sides that press on the core parts must permit greater tolerances of the core parts and therefore have greater lips and spring deflections.

Another advantage is that the spring cap is only bent in the Hooke area and can therefore be reused or recycled.

An additional advantage of the frictional resistance of the handle-spring shackles, when compared to the conventional design with traction, is that the co-planar aspect of the underside of the electrical component, e.g. the transformer, is improved since there is no tensile stress on the exterior areas of the connector. This means that the connector bends less, and the contacts of the component that can be surface mounted can be soldered on the circuit board more reliably and with less tolerance. It also saves on solder.

Another advantage of the invention consists in the fact that manufacture of the spring cap is simplified because the yoke is planar, and the process for manufacturing the concave area is eliminated. This means that one tool and two procedures are eliminated.

Additional information on the invention can be read in the subsidiary claims.

The invention is described in more detail below using a design example in the Figures in the drawing. These show:

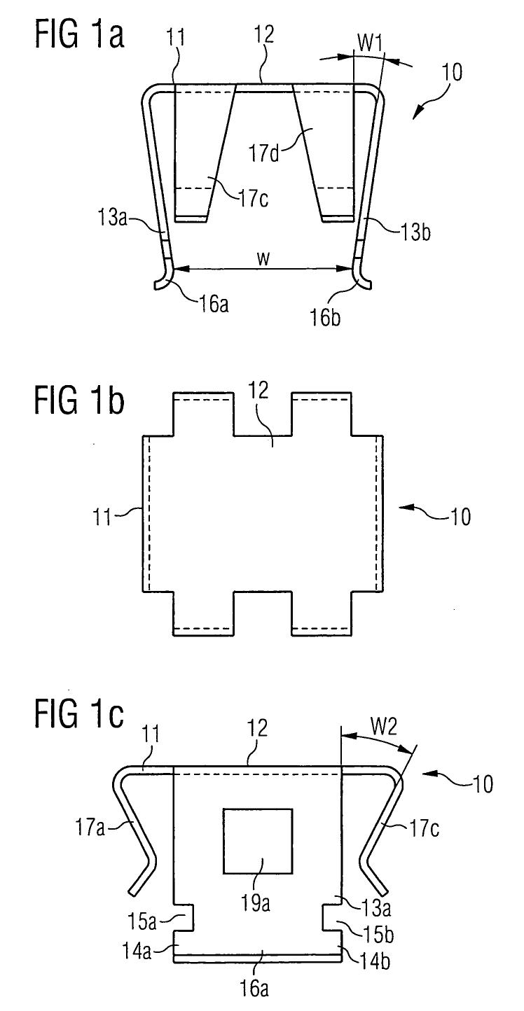

FIG. 1 shows a view from above and two lateral views of the spring cap;

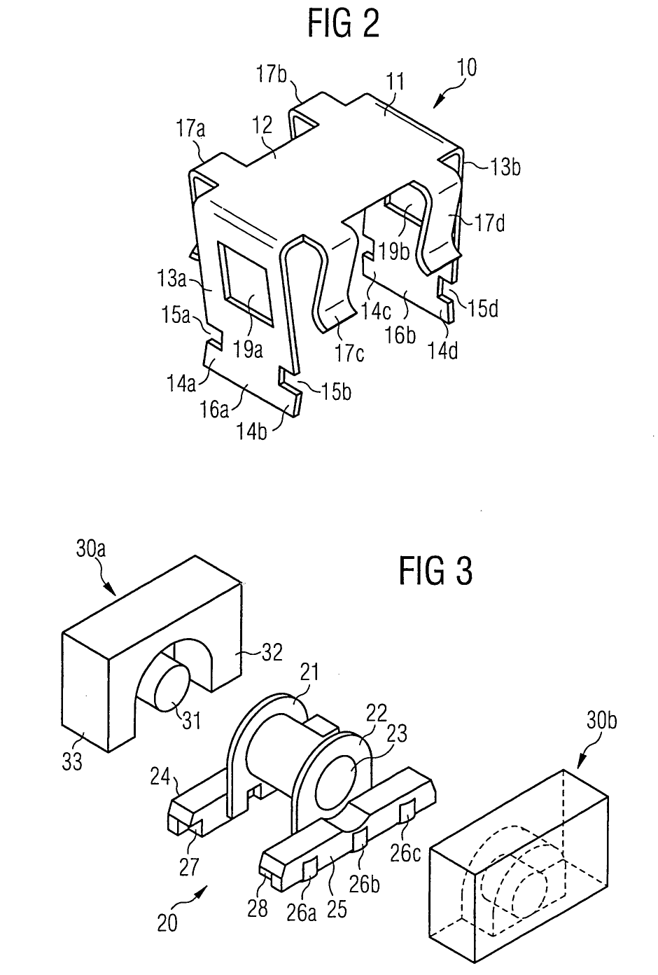

FIG. 2 shows a view in perspective of the spring cap; and

FIG. 3 shows a view in perspective of the bobbin with core halves that can be attached. Looked at together, FIG. 2 and FIG. 3 show an enlarged view of an inductive electrical component.

In the figures, the same elements have the same designations.

In FIGS. 1 and 2, the spring cap 10 has a yoke 11, which at least in its central area has a planar design. On this yoke 11, on two opposite sides, there are handles 13a, 13b, which have snap-on lugs 14a, 14b and/or 14c, 14d, which are preferably bent outwards in each case from the surface of the handles 13. These snap-on lugs 14 are designed by the handles 13 having notches 15a, 15b and/or 15c, 15d in the area of their free ends. The handles 13 continue on each side of the notches 15 in lips 16a, 16b. The sparse width W between the lips corresponds to the dimensions of the connectors 24, 25 of the bobbin 20, producing frictional contact between the handle-spring shackles 13 and the connectors 24, 25. In FIG. 1, the lips have a bent shape and in FIG. 2 a straight shape bent against the other surface of the handles 13. So as to be able to act as spring shackles, the main surface of the handles is angled against the perpendicular by an angle W1. Since the tolerances of the connectors are very small, the angle W1 can move in a predetermined range of angles, e.g. between say 1° and 10°, but in any case can also be smaller or larger than those values.

In the other plane that is perpendicular to the yoke 11 of the spring cap 10, spring shackles 17a, 17b, 17c and 17d are provided on the yoke 11. The function of the spring shackles is to clamp the core halves 30, the tolerances of which are greater than those of the connectors. Angle W2 of the spring shackles against the perpendicular is preferably between 20° and 40°, the same as the angles of the lips of the spring shackles 17. In this case also, smaller or larger angles are possible.

To further enhance stability, recesses 19 are provided in the handles 13 of the spring cap 10 over which the spring cap 10 can be stuck with the core halves 30.

Reference is made to the introductory explanations for the general design shape of the bobbin 20 and the magnetic core in the form of two magnetic core halves as shown in FIG. 3.

A design of an electrical component, e.g. a transformer, has a bobbin 20 and a so-called E-core or EP-core 30a, 30b which can be put on top of this, which is preferably made of ferrite material and is composed of several parts, e.g. two core halves. The bobbin 20 has a coil space demarcated by two external bobbin flanges 21, 22 with a cylindrical through-hole 23 to receive the central bosses 31 of the EP-core halves. Q-cores can be used as well as E-cores. The bobbin 20 also has attached connectors 24, 25 which are, for example, made as one piece with the bobbin, and contain contact pins 26a, 26b, 26c for electrical contact of the component after it is mounted on a printed circuit board. The connections are designed in such a way that the mounted component can be surface mounted.

The two EP-core halves 30 in the example with central bosses 31 and core handles 32, 33 can be pushed onto the bobbin 20 so that the central bosses mate with the cylindrical through-hole 23.

In the design example, the core halves 30a, 30b are held on the bobbin by means of the spring cap 10. When the spring cap is pushed up, the spring shackles 17 attach to the external sides of the magnetic core.

Accordingly, the bobbin 20 has, by adjusting the snap-on lugs 14 of the spring cap 10 at the free ends of the connectors 24, 25, underside notches 27, 28 which can be formed by adding lugs to the connectors. The handle-spring shackles 13 are adjacent to the outer sides of the connectors 24, 25 and snap on by means of the snap-on lugs 14 to the related underside notches 27, 28 of the connectors and to the corresponding underside notches (not shown) of the connectors on the opposite side of the bobbin.

If, after the magnetic core halves 30 are pushed up onto the bobbin 20 so that the central bosses 31 mate with the cylindrical through-hole 23 and the outer handles 32, 33 sit on the flanges 21, 22, the spring cap 10 is pushed from above onto the unit from bobbin 20 and magnetic core 30, then the snap-on lugs 14 snap on the underside notches 27, 28 and the underside notches of the opposite side. The dimension of the notches 15 is of a size such that the snap-on lugs only ensure that the spring cap does not come off, but have no traction with the underside notches. The function of securing the handles of the spring cap is done by frictional resistance between the lips 16 and the connectors 24, 25. The core halves 30 are held together in the direction of the magnetic axis by the spring shackles 17.

In this way, the core halves 30 are held securely on the bobbin 20 in two directions that are perpendicular to each other, thus preventing any impairment of the electromagnetic properties of the inductive component.

1. Spring cap, specifically for an inductive electrical component, which has a yoke and handles on two opposite sides and spring shackles on two opposite sides,
characterized by the fact that the yoke (11) has a central planar area (12), and the handles (13a, 13b) are designed as spring shackles.

2. Spring cap described in claim 1,
characterized by the fact that the yoke has a planar design throughout.

3. Spring cap as described in claim 1 or 2,
characterized by the fact that the main surface of the handles (13) is angled under a predetermined angle (W1) against the perpendicular axis onto the yoke (11).

4. Spring cap as described in one of the claims 1 to 3,
characterized by the fact that the handles (13) are longer than the spring shackles (17, 18), so that the respective spring force has an effect in various planes.

5. Spring cap as described in one of the claims 1 to 4,
characterized by the fact that each handle has snap-on lugs (14) in order to mate with related underside notches (27, 28) of an element configured between the handles.

6. Spring cap as described in claim 5,
characterized by the fact that the snap-on lugs (14) are formed by notches (15) in the area of the free ends of the handles (13).

7. Spring cap as described in one of the claims 1 to 6,
characterized by the fact that the free ends of the handles (13) are bent outwards from the surface of the handles.

8. Spring cap as described in one of the claims 1 to 7,
characterized by the fact that the handles contain recesses (19).

9. Electrical component, specifically an electrical transformer, which has:
a bobbin with bobbin flanges at the end and attached connectors,
a divided magnetic core, the parts of which mate with the bobbin by means of a central boss and
a spring cap which can be pushed up on the core which is mated with the bobbin, which spring cap contains a yoke and handles on two opposite sides and spring shackles on two opposite sides, whereby when the spring cap is pushed up, the handles are in contact with the connectors, and the spring shackles are in contact with the magnetic core
characterized by the fact that the yoke (11) has a central planar area (12), and the handles (13a, 13b) are designed as spring shackles which with their free ends press against the contact pins (27,28).

10. Electrical component as described in claim 11,
characterized by the fact that the yoke (11) of the spring cap (10) has a planar design throughout.

11. Electrical component as described in claim 9 or 10,
characterized by the fact that the main surface of the handles (13) of the spring cap (10) is angled under a predetermined angle (W1) against the perpendicular axis onto the yoke (11).

12. Electrical component as described in one of the claims 9 to 1,
characterized by the fact that the handles (13) of the spring cap have in each case snap-on lugs (14), and the connectors (24, 25) have at their free ends underside notches (27, 28) so that the snap-on lugs can mate when the spring shackle is pushed up.

13. Electrical component as described in claim 12
characterized by the fact that the snap-on lugs (14) are formed by notches (15) in the area of the free ends of the handles (15).

14. Electrical component as described in one of the claims 9 to 13,
characterized by the fact that the free ends of the handles (13) of the spring cap (10) are bent outwards from the surface of the handles.

15. Electrical component as described in one of the claims 9 to 14,
characterized by the fact that the handles (13) of the spring cap (10) contain recesses (19).
